(19) United States
(12) Patent Application Publication
(10) Pub. No.: US 2002/0169889 A1
(43) Pub. Date: Nov. 14, 2002

(54) Zero-loss web service system and method

(76) Inventors: Chu-Sing Yang, Tainan City (TW); Mon-Yen Luo, Pintung Hsien (TW)

Correspondence Address: BAKER & McKENZIE, ATTORNEYS AT LAW, HUNG TAI CENTER, 15TH FLOOR, 168 TUN HWA NORTH ROAD, TAIPEI, 105, TW

(21) Appl. No.: 10/126,932

(22) Filed: Apr. 22, 2002

(30) Foreign Application Priority Data
Apr. 26, 2001 (TW) 90110053

(51) Int. Cl. G06F 15/173

(52) U.S. Cl. 709/244; 709/238

(57) ABSTRACT

A zero-loss web service system for providing World Wide Web access service to clients connecting via the Internet and sending requests to said system for said access, wherein the system comprises a server cluster and a dispatcher device. The server cluster comprises a number of servers connected in a network. The dispatcher device comprises a routing mechanism, the dispatcher dispatching each of the access requests sent by the clients to a corresponding one of the servers in the cluster, and the routing mechanism discriminating each of the requests sent by the clients and migrating the requests to another server in the event that the corresponding server suffers a service failure.

### FIELD OF THE INVENTION

This invention relates in general to a system and method for web service and, in particular, to a system and method for fault-tolerant web services. More particularly, this invention relates to a fault-tolerant web service system and method capable of enduring server failures and overloads to achieve zero loss of service.

### BACKGROUND OF THE INVENTION

The World Wide Web on the Internet has become an important, even vital in many situations, vehicle for a vast variety of commercial services. Service reliability of web servers becomes a great concern for both the client and the service provider. Modern web servers must cope with many more challenging problems than ever before. This is due to the fact that web services have become more numerous, varied, and sophisticated in nature.

The World Wide Web has evolved from its initial role as a provider of read-only documentation-based information to a platform that supports complex services. In order to provide satisfactory service, a web server must be able to serve thousands of simultaneous client requests while also having the capability to scale itself to cope with a rapidly growing user population and explosive content growth.

Typically, the popularity and credibility of a web site is based on rapid response and high reliability and the site can suffer from two major problems: server failure and overload. Server failure is a reliability issue that may be caused by various types of hardware malfunctions while server overload typically leads to sluggish client responses. Denial of Service in today's highly competitive business environment can mean significant lost revenues and irreparably damaged credibility.

In order to maintain efficient web service, a number of approaches have been disclosed in the prior art. Server replication, or, server clustering, as discussed in “Cluster-based scalable network services” by Fox et al., Proceedings of the SOSP '97, October 1997, is a promising solution and numerous server-clustering schemes have been proposed over the past few years. Examples include client-side approach as discussed in “Using smart clients to build scalable services” by C. Yoshikawa et al., Proceedings of the 1997 USENIX Annual Technical Conference, Jan. 6-10, 1997; DNS aliasing such as described in “NCSA's world wide web server: design and performance” by R. McGrath et al., IEEE Computer, November 1995; TCP connection routing such as in, “A scalable and highly available web server” by D. Dias et al, Proceedings of the COMPCON '96, February 1996, “Design and implementation of an environment for building scalable and highly available web server” by C. S. Yang et al., Proceedings of the 1998 International Symposium on Internet Technology, Apr. 29-May 1, 1998, and “Network dispatcher: a connection router for scalable Internet services” by G. D. H. Hunt et al., Proceedings of the 7th International World Wide Web Conference, April 1998; and HTTP redirection in “Towards a scalable distributed WWW server on networked workstations” by D. Andresen et al., Journal of Parallel and Distributed Computing, Vol 42, pp. 91-100, 1997, etc. These approaches can indeed provide efficient web performance and scalability, and high availability via redundancy; however, service fault resilience is not guaranteed.

Most of the prior work on web server clusters has concentrated on request distribution among a group of server nodes. However, server systems clustered in these schemes or products only provide high availability by redundancy. They do not address one fault resilience problem.

Ingham et al. in “Constructing dependable Web services,” IEEE Internet Computing, Vol. 4, January/February 2000 presented a survey of some approaches for constructing a highly-dependable Web server wherein the importance of providing transactional integrity was pointed out and it was noted that transactional integrity has not been addressed in existing systems. Y M. Wang et al. in “HAWA: a client-side approach to high-availability web access,” Proceedings of the Sixth International World Wide Web Conference, April 1997 addressed the service availability problem on the client side utilizing an applet-based approach which has the advantage of low overhead. However, neither Ingham nor Wang addressed server-side fault tolerance problem and transaction-based service. Singhai et al. in “The SunSCALR framework for Internet servers,” Proceedings of the 28th Annual International Symposium on Fault-Tolerant Computing, June 1998 and Chawathe et al. in “System support for scalable and fault-tolerant Internet services,” Proceedings of Middleware '98, September 1998 proposed a framework for building a high-availability Internet service system, but fault-tolerance and high-reliability were not addressed.

In a conventional clustered server system, when failure of any server node is detected, transparent replacement by an available redundant server is utilized to maintain service availability. However, any ongoing requests on the failed server will be lost. In addition to the detection and masking of the failures, an ideal highly-reliable server system should enable the outstanding requests on the failed node to be smoothly migrated and recovered on another working node of the system.

Another flaw in much of the conventional server clusters is the lack of adaptability to surging load bursts. In addition to the rapidly growing client population, the Web is also well known for its highly-varied load conditions. Certain events may trigger significant load bursts that persists for hours, or even days. Examples include announcement of a new version of popular software or products, or, a site cited as “Best Site of the Month,” etc. As a result, some nodes in the cluster could eventually become swamped due to exposure to far more requests than it was originally configured to handle. This problem is particularly troubling for sites that offer E-commerce services since the requests for popular pages may overwhelm the requests for more important services (e.g., merchant services or services for preferred customers). The requests for these critical services should remain available even when the server is heavily loaded, or they should enjoy higher priority than other trivial requests.

### SUMMARY OF THE INVENTION

It is therefore an object of the present invention to provide a zero-loss web service system and method that allows the on-going web service access request of a remote client to survive a server failure.

It is another object of the present invention to provide a zero-loss web service system and method that allows the on-going web service access request of a remote client to survive a server overload.

It is still another object of the present invention to provide a zero-loss web service system and method that is capable of adapting to excessive load surges.

It is yet another object of the present invention to provide smooth service provision while request migration is occurring.

The present invention achieves the above and other objects by the integration of content-aware routing, connection pre-forking and reutilization, seamless relay of packets between two TCP connections, and fault recovery mechanism to effectively provide fault resilience in a zero-loss communications system for providing client network access service to a server cluster through a dispatcher including a routing mechanism, for routing access requests from clients and migrating the access requests to another server in the event that a server suffers a service failure.

### BRIEF DESCRIPTION OF THE DRAWINGS

Other objects, features, and advantages of the present invention will become apparent by way of the following detailed description of the preferred but non-limiting embodiments. The description is made with reference to the accompanied drawings in which:

FIG. 1 schematically illustrating a system implementing web access service that incorporates the zero-loss web service system and method of the invention;

FIG. 2 is a time diagram illustrating the protocol for the processing of session-based service requests in accordance with an embodiment of the invention;

FIG. 3 is a block diagram illustrating the dispatcher device having a multiple number of discrete dispatchers for preventing the single-point-of-failure drawback in the web server system of the invention; and

FIG. 4 is a flow chart illustrating the method of request processing in the event of server failure in accordance with a preferred embodiment of the invention;

### DETAILED DESCRIPTION OF THE INVENTION

In order to provide zero-loss web service, a mechanism is devised by the present invention that enables a web request to be smoothly migrated and recovered on another working node in case of server failure or overload, thereby providing a zero-loss web service. In other words, the system in accordance with the preferred embodiments of the invention ensures that the service of any user-submitted request suffers zero loss even in the case of a server failure or overload as the focus is on the server side.

In a preferred embodiment of the inventive clustered server of the invention, a request-routing mechanism is needed to dispatch and route the incoming request to the server best suited to respond. To effectively support zero-loss web services, the request-routing mechanism must have two capabilities, namely, the discrimination and migration of incoming requests. The administrator of the system can explicitly prioritize certain services so that they will enjoy guaranteed fault-tolerant support or higher performance.

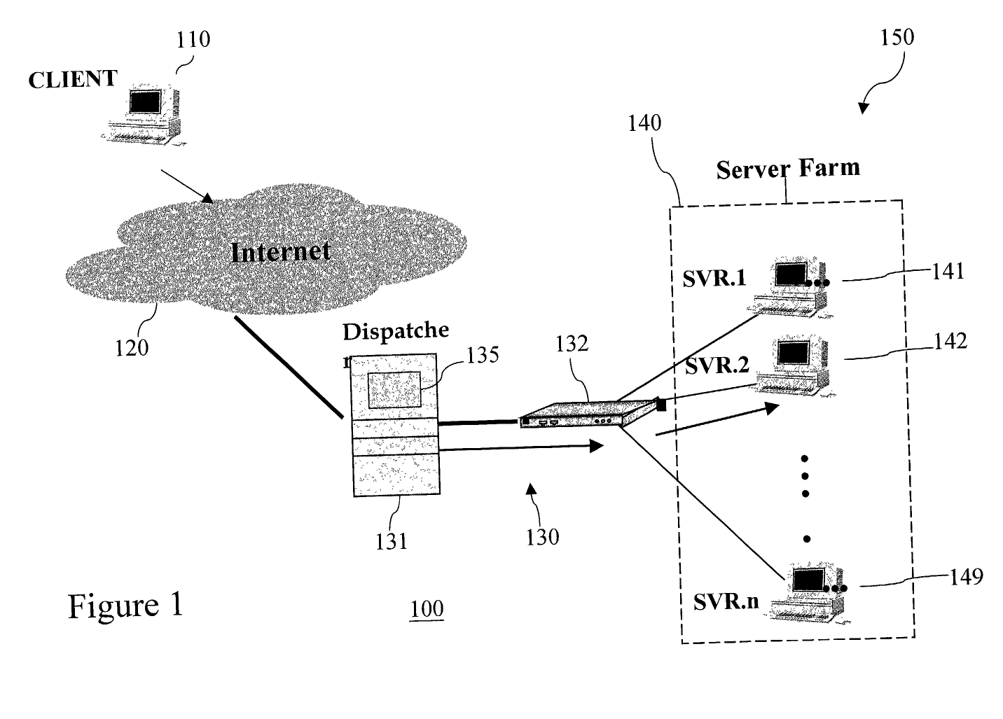

FIG. 1 schematically illustrates a system implementing World Wide Web access service that incorporates a zero-loss web service system 100 of the invention. In the system, a user (or client) 110 accesses a particular web site 150 for a desired service. The site 150 has a number of servers 141, 142, . . . , 149 organized as a server cluster 140. The cluster 140 is connected via a dispatcher 130 instead of directly to a Network 120 (an example being the Internet).

Note here that the dispatcher 130 shown in the illustrative example of FIG. 1 comprises a dispatcher device 131 and a network switching device 132. As is comprehensible for persons skilled in the art, the dispatcher 130 may also be a single and dedicated microcomputer or a microcontroller-based dispatching device that does not require a companion network switch device 132 (as illustrated in FIG. 1). In FIG. 1 however, the dispatcher device 131 may be a PC-based dedicated dispatching computer that serves the purpose as described herein.

The dispatcher 130 is responsible for dispatching the access request as issued by the client 110 to a suitable server in the server cluster 140 (what constitutes “suitable” shall be described below). As will be described in the following paragraphs, for each and every one of the user's requests, the dispatcher 130 assigns the incoming request to a selected server of the server cluster 140 for processing; however, the outgoing response information as provided by the assigned server in the cluster 140 is typically not processed by the dispatcher 130. The dispatcher 130 simply relays the response information back to the requesting client 110 via the Network 120. To achieve this, the dispatcher 130 needs to implement a routing mechanism, which is conceptually shown in the drawing by reference numeral 135.

To achieve zero loss for a web service in case of server failure or overload, this routing mechanism 135 implemented by the dispatcher 130 for the service in the server cluster 140 of the site should have two important capabilities: status logging and recovery. That is, certain intermediate states of the user's requests needs to be logged by the logger mechanism. When server failure arises, the recovery mechanism can pick up the outstanding requests on the failed (or overloaded) node to continue processing on another server. This requires a valid set of intermediate states for the newly-assigned working node.

However, the effort will become excessively impractical if all incoming requests are to be logged. In modern web sites, the service type of incoming requests can be categorized either as for static web pages, dynamic content generated such as by Cell Global Identity (CGI) scripts, or transaction-based services. It is not necessary to log all requests in order to facilitate request recovery. Thus, the routing mechanism 135 for the web server cluster 140 must have “content-awareness” so that it can differentiate which requests are critical to recovery. The matter of how a failed web request can be recovered and processing continued in another working node is another complicated issue, but at a minimum, such a recovery mechanism must be transparent to user and needs to be performed smoothly.

Request Discrimination

An embodiment of a basic request routing mechanism according to the present invention is built around the dispatcher 130. In FIG. 1, the dispatcher node, say, for example, node 131, that executes the routing mechanism 135 pre-forks a number of trunk connections to the back-end nodes, and then allocates system resources by dispatching client requests on these trunks. The following illustrative example adopts an Internet network for descriptive convenience, it being understood that any network 120, including corporate intranets, personal networks, home networks and the like, are all within the contemplation of the present invention. When client 110 attempts to retrieve a specific content, first a client-side browser needs to create a Transmission Control Protocol (TCP) connection. The incoming TCP connection requests are acknowledged and handled by the dispatcher 130 until the client 110 sends packets conveying the Hypertext Transfer Protocol (HTTP) request, which contains the Universal Resource Locater (URL) which specifies the specific content requested. and other HTTP client header information (e.g., host, cookie, etc.).

At that point, the dispatcher 130 looks into the HTTP header to make a decision on how the request can be routed. When the dispatcher 130 selects a server from the server cluster 140 that is best suited to this request, it then chooses an idle pre-forked connection from the available connection list of the target server. The dispatcher then stores related information (e.g., TCP states) about the selected connection in an internal data structure termed a “mapping table,” binding the user connection to the pre-forked connection. After the connection binding is thus determined, the dispatcher 130 handles the consequent packets by changing each packet's Internet Protocol (IP) and TCP headers for seamlessly relaying the packet between the user connection and the pre-forked connection, so that the selected server can transparently receive and recognize these packets.

On top of the basic routing mechanism 135, a loadable module 136 (conceptually shown) is inserted according to the present invention into the kernel of the back-end servers 140. The module inserts itself between the network interface (NIC) driver and the TCP/IP stack. The purpose of the loadable module 136 is two-fold. First, the dispatcher 130 may send the binding information to the loadable module 136, and the loadable module 136 then changes the outgoing packets so that the packets go directly to the client 110 without going through the dispatcher 130. As a result, the processing burden of the dispatcher 130 can be greatly reduced, since the information size sent from the selected server to client 110 is significantly larger than that from client 110 to the selected server. The second purpose of such a design is for preventing the single-point-of-failure problem, which will be described in the following paragraphs.

Based on the request routing mechanism as described above, the dispatcher 130 requires a certain level of intelligence to be able to discriminate incoming requests in order to make routing decisions. To address this, the present invention provides an internal data structure, the URL table, which is constructed to maintain the content-related information. This URL table includes information such as size, type, priority, assigned processing nodes of the content, etc. The dispatcher 130 consults the URL table when assigning an incoming request to one of the back-end servers. In the preferred embodiment, the URL table models the hierarchical structure of the content stored in the web site. This concept of the present invention is based on the observation that content is generally organized utilizing a directory-based hierarchical structure. This implies that a file in the same directory usually possesses the same properties. For example, files underneath the /CGI-bin/directory generally are CGI scripts for generating dynamic content.

Consequently, the URL table according to an embodiment of the present invention is implemented as a multi-level hash tree, in which each level corresponds to a level in the content tree and each node represents a file or directory. Basically, each item (file or directory) of content in a web site should have a corresponding record in the URL table. However, in order to reduce search time and extent, the URL table of the present invention supports a “wildcard” mechanism for specifying a set of items that are directed toward the same properties. For example, if all items underneath the sub-directory “/html/” are all hosted in the same nodes and have the same content type, only the entry “/html/” exists in the URL table. If the dispatcher intends to search the URL table to retrieve information pertaining to a URL “/html/misc.html”, it can get the information from the node “/html” in the table by searching just one level. The URL table is in general self-generated, maintained, and managed by a management system via parsing the content tree. A network administrator may also configure the URL table if necessary.

Request Migration

With the routing mechanism 135 equipped with request discrimination capability, a preferred embodiment of the system of the present invention performs request migration in case of server failure concomitant with the processing of a request. The system and method in accordance with the preferred embodiment of the present invention allows for a smooth migration and recovery of on-going requests in case of server failure or overload. Further, to facilitate request migration and recovery, the system requires a status-detection mechanism that can quickly identify the occurrence of server overload or failure.

In general, web requests can be categorized as three types of requests: requests for static contents, requests for dynamic contents, and requests for session-based services. Each request category may have a corresponding solution of migration and recovery. The dispatcher can identify the type of each request via, for example, consulting the URL table, and then migrate the requests of each category with the corresponding approach in case of server failure or overload.

Requests for Static Content

Significant portions of all web requests are for static objects such as HTML files, images, and audio/video clips. The mechanism of the present invention can be used to migrate such static-content requests to another node in the server cluster 140. To do this, first, the dispatcher 130 selects a new server (based on, for example, some load balancing mechanism), and then selects an idle pre-forked connection connected with the target server. Then the dispatcher re-binds the client-side connection to the newly selected server-side connection. After the new connection binding is determined, the dispatcher 130 issues a range request on the new server-side connection to the selected server node. The range request is defined in the HTTP 1.1 protocol, which allows a client to request portions of a resource. Using this property, a request may be enabled to continue downloading a file from another node after the transfer was terminated in mid-stream due to failure.

Based on TCP-related information (i.e., ACK number, sequence number) recorded in the mapping table, the dispatcher 130 can infer how many bytes the client 110 has successfully received. As a result, the dispatcher 130 can then make a range request by including the Range header in it, specifying the desired ranges of bytes (generally starts from the last acknowledge number from the clients).

Integrating the techniques of reutilization of pre-forked connection and seamless relay of packets between two TCP connections, a failed request can be recovered smoothly on another node in the system. It is noteworthy that the response of a range request has a unique HTTP header (e.g. carries the 206 status code), compared to the header of a usual response. Such a difference also needs to be translated by the loadable module 136 of back-end servers of the server cluster 140.

Requests for Dynamic Contents

Some web requests are for dynamic contents, for which responses are created on demand (e.g., CGI scripts, ASPs, etc.), mostly based on client-provided arguments. A failed request for dynamic content can not be migrated and recovered by simply replaying the request with the same argument to another server node. The major problem is that some dynamic requests are not “idempotent.” That is, the results of two successive requests for dynamic content with the same argument are not necessarily the same. The most common example is dynamic web pages constructed from a database. The two successive requests to the same page may be different due to database updates. This means that it is impossible to “seam” the results of the two requests by the range request approach described above for the static content requests. If an attempt is made to recover any dynamic request on another node, the client 110 will have to give up those portions of the result already being received and resubmit the same request again. Of course, such an approach is not user-friendly and may be incompatible with existing browsers.

Consequently, the present invention solves this problem utilizing the following approach. The dispatcher 130 is made to “store and then forward” the response of a dynamic request. In other words, the dispatcher 130 will not relay the response to the client 110 until it receives the complete result. Hence, if the server node fails in the middle of a dynamic request, the dispatcher 130 will abort this connection and resubmit the same request to another node. Only when the complete result is received will the dispatcher 130 commence its reply to the client 110.

While this solves the idempotent problem, this approach however has two potential drawbacks. First, the dispatcher 130 may suffer from the problem of single-point-of-failure. In another embodiment of the the invention to be described in later paragraphs, this problem will be addressed and resolved. Second, storing the server response in the dispatcher 130, even only temporarily, may degrade performance of the dispatcher 130 that negatively affects the throughput of the entire server system. In general however, the performance impact is not serious because the size of a dynamic web page is usually small.

In order to completely eliminate the performance degradation concern, the dispatcher 130 can be made to function as a reverse proxy (or Web server). That is, the dispatcher 130 caches the dynamic page so that the subsequent requests for the same dynamic page can access the content from the cache instead of repeatedly invoking a program to generate the same page.

In an experiment, this algorithm was implemented to manage cached dynamic Web pages. Test results showed that the system embodying the present invention not only performed failure recovery, the overall performance also increased significantly because it avoided repeated requests for dynamic content which considerably slow down the Web server. With the design of the present invention, the idempotent dynamic requests can be served directly from the memory cache, reducing the burden of the back-end Web server.

Requests for Session-Based Services

Within a web access session, a number of user interactions may be involved. Here the user does not simply browse a number of independent statically or dynamically generated pages, but is guided through a session controlled by a server-side program such as a CGI script associated with certain shared states. For example, such a state might contain the contents of an electronic “shopping cart” (a purchase list in a shopping web site) or a list of results from a search request.

These session-based services are generally based on the so-called “three-tier” architecture, which consists of the front-end client (e.g. browser), middle-tier Web server, and back-end database server. Basically, the front-end client provides user interface so that the user may use it to send the requests to the web server for service access. The web server, on the other hand, implements application and/or business logic. It processes the client's request, commits it to the database server, stores the resulting state, and returns the results to the client. Database servers, as is known, manage data and transactional operation at the back end.

If a failure occurs at the web server in the middle of a session, the end-user typically cannot acquire any information that can be an indication of what actually happened and whether or not the request was successfully committed. They may just wait until a timeout expires at the client side. Some users may re-send their requests, however, these requests will not be answered since their states have been lost. Other users may re-submit all requests to retry the session, which will raise the risk of executing the transaction more than one time, possibly causing the undesirable effect of the user being charged multiple times for one transaction, leading to severe annoyance and serious tarnishment of the credibility of the very web site blamed for the service interruption.

Recovering a session on another node involves more complexities. It requires knowledge of application-specific details such as when a session began, the internal state, the intermediate parameter, when the session ended, and so on. A mechanism to replicate the intermediate processing-states is also needed in order to ensure the fault-tolerance of the session itself

First of all, sessions requiring fault resilience or higher performance should be defined by the website manager. For example, the manager can define the action “user adding the first item into a shopping cart on a specific web page” as a sign of the beginning of a session. Further, the administrator can define the action “user clicking the check-out button” as the end of this session. The administrator may make these configurations easily via the GUI of a management system.

Such configuration information can be stored in the URL table. As described above, the dispatcher 130 consults the URL table to assign an incoming request to one of the web servers of server cluster 140. When the dispatcher 130 finds (by “discrimination”) a request conveying the “start” action, it tags this client and then direct all subsequent requests from the very client to one of the twin servers until it finds a request conveying the “end” action.

The twin server is a logical couple of servers, which include a primary server and a backup server. The primary server is a regular web server that is dedicated to providing transaction service. The backup server, on the other hand, is responsible for providing back-up for the primary server. The primary and backup servers teamed up to constitute a twin-server pair, as is comprehensible, may be selected by the system from among the server cluster.

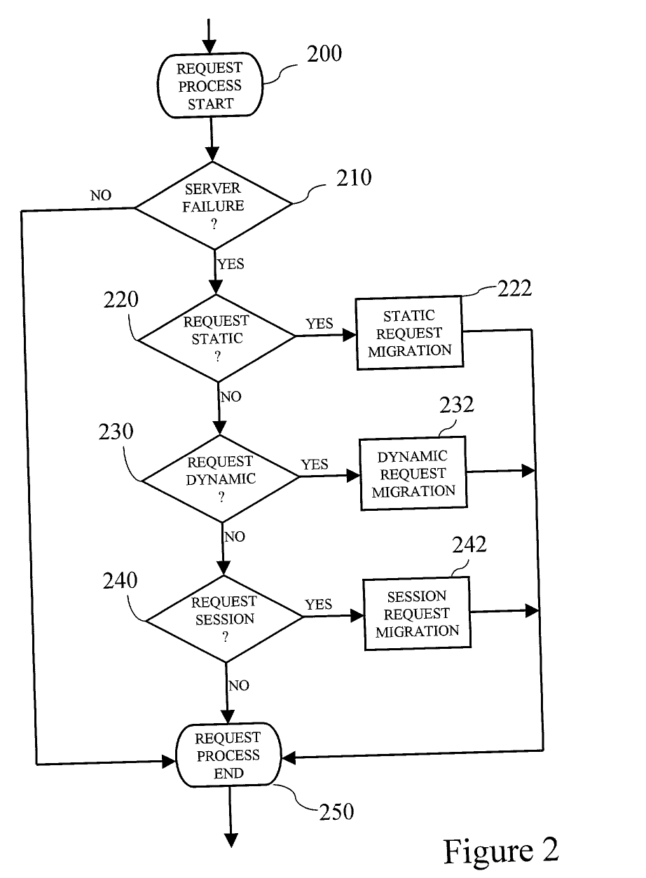

The backup server maintains two IP addresses. One is its own address and the other is the address of the primary server. An alias of the IP address of the primary server is provided on the network interface so that the local protocol stack will accept the corresponding incoming packets to that address. However, the backup server does not export the alias address via Address Resolution Protocol (ARP), since that would create an IP-address conflict. In addition, one backup node can simultaneously serve as the backup of multiple servers. The protocol executed by the twin server is schematically outlined in a timing diagram in FIG. 2.

As schematically illustrated in FIG. 2, when a client at 210 issues a Client Request 211 that is categorized as session-based by the routing mechanism (136 in FIG. 1), the dispatcher 130 (also in FIG. 1) directs it to a primary server at 220. Because a backup server 240 can receive all packets destined to the primary server 220 by employing the alias of its address, an HTTP daemon (not shown) in the backup server 240 will also receive Client Request 211 as a Backup Client Request 212 to backup server and then synchronize with the primary server 220 by “silently” logging this request with Log Request 213. The backup server 240 is thus able to maintain the same “session processing state” as that in the primary server 220. However, the HTTP daemon in backup server 240 does not deliver any packet or result unless the primary server 220 fails. This ensures that the client 210 receives only a single result.

After the backup server 240 has successfully recorded this request by Log Request 213, it sends a “go for it” message Go for It 214 to the primary server 220 for Client Request 211. Unless the primary server 220 receives message Go for It 214, the primary server 220 cannot commit this Client Request 211 to the database server 250. If the primary server 220 waits for the message Go for It 214 for a sufficiently long time, it will actively send the backup server 240 a message to log this request and then waits for the message Go for It 214 again. If it still does not receive a Go for It 214, it suspects the backup server 240 itself has failed and will then create a new backup.

When the primary server 220 does receive the Go for It message 214, the Client Request 211 then triggers a protocol of Two-Phase Commit 215 with the database server 250, which ensures that the request agrees on the transaction semantic. When the database server 250 replies with the Database Server Reply 216, the primary server 220 sends the backup server 240 a message Log the Outcome 217 in order to log the upcoming outcome before it commits this request to the database server 250. After receiving an Outcome Log Ack message 218 from the backup server 240, the primary server 220 then formally commits the client's request by issuing Commit the Request 219 to the database server 250.

When the database server 250 finishes this transaction in response to Commit the Request 219, it replies with a Database Server Ack message 221 to the primary server 220. At the same time, the backup server 240 also receives Database Server Ack message 221 due to the aliased address. Then, backup server 240 also sends a Backup Server Ack message 222 to inform the primary server 220 that it has logged the result of this transaction. After receiving both of the Ack messages 221 and 222, the primary server 220 sends a Result Page 223 to the client 210. When both the primary server 220 and backup server 240 receive a Client Ack message 224 from the client 210, they conclude the protocol and the backup server 240 may now instruct the backup server 240 to releases its logged data by issuing the message Release Logged Data 225 to the backup server 240 as the whole session is over. When the primary server 220 fails or is overloaded, the backup server 240 can take over the job of the primary server 220 by activating the alias address, and then the HTTP daemon starts to deliver data with the replicated state instead of the primary server 220 delivering the data.

It is noteworthy that the dispatcher 130 does not need to know whether or not the primary server 220 has failed. The dispatcher 130 always relays packets to the “representative” address (i.e. the alias IP address). As long as a backup server is able to take over the a primary server's job and activate the alias address, the web hosting service remains uninterrupted even if the primary server fails. This invention thus relieves the burden of a dispatcher and enhances the overall system performance.

In an embodiment of the present invention, an Apache server was modified to realize the above protocol. The Apache server was extended to implement the protocol because of its openness, reliability, efficiency and popularity. Apache follows the per-process-per-request model to handle incoming requests. It pre-forks a set of processes and each process calls the accept ( ) system call to accept new connections. In general, Apache handles a request in a series of steps: (1) accepts a request, (2) parses its arguments for later use, (3) translates URL, (4) checks access authorization, (5) determines MIME type of file requested, (6) processes the request, (7) sends response back to client, and (8) logs the request. For the implementation of this invention, a decision-logic was inserted in step 6. If the process pertains to a primary server, it sends a log message to the backup server and waits for its reply. The program will not submit the request to the database until it receives the backup's reply. The log message is composed of source IP address and port number of the client, and the process ID. If the process pertains to a backup server, it does not really process the request but instead waits for the log message from the primary server. That means it will keep the same processing state with the primary server but skip step (7).

As mentioned above, the dispatcher 130 of FIG. 1 may encounter a problem known as “single-point-of-failure.” That is, a failure of the dispatcher brings down the entire server system. As in FIG. 1, the dispatcher 130 may be a potential impediment to scalability due to the centralized design and software-based implementation. However, a performance evaluation conducted utilizing an implementation based on the embodiment of the present invention described above showed that good scalability is achieved.

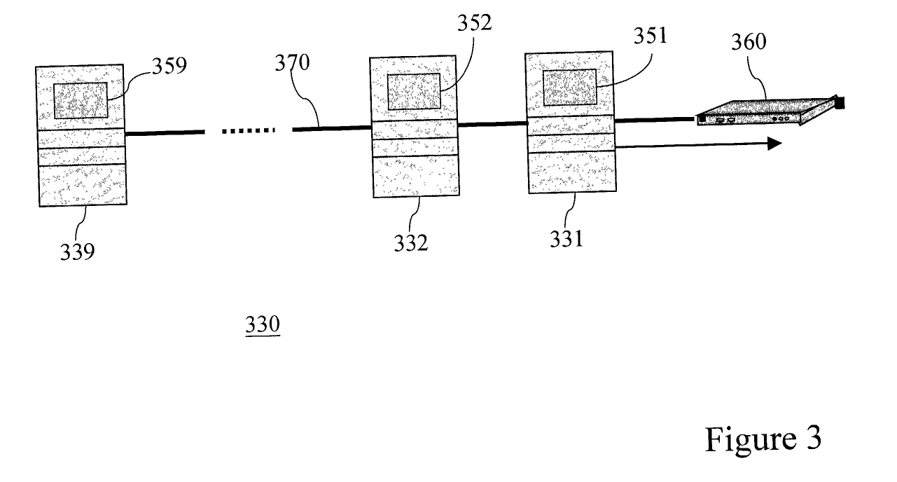

To further improve scalability and fault tolerance for the system illustrated in FIG. 1, another embodiment of the present invention having a dispatcher 330 is illustrated in FIG. 3. A plurality of dispatchers 331, 332, . . . , 339 cooperate as a whole for distributing incoming requests. Note again that each of the dispatchers 331, 332, . . . , 339 may also be a single and dedicated microcomputer- or microcontroller-based dispatching device that does not require the companion of a network switch device such as 360 illustrated in the drawing. In FIG. 3, each of the dispatcher devices 331, 332, . . . , 339 also may be a PC-based dedicated dispatching computer and connected to a network 360. In this configuration, the DNS approach, for example, can be used to map different clients to different dispatchers. A collection of daemon processes that provide fault tolerance facilities on the group of dispatcher nodes 331, 332, . . . , 339 and logically configured as a ring was implemented in an experimental setup. The daemon processes were based on the SwiFT toolkit. Each dispatcher node runs a daemon process that monitors and backs up the status of its logical neighbor.

During the evaluation, all dispatchers participated in load sharing under normal operating conditions. No dispatcher was relegated to an idle hot standby status waiting for the failure of a primary dispatcher. Operation of the dispatcher(s) is based on two important states: the URL table and the connection binding information. The URL table is a soft state that can be regenerated after a server failure. In contrast, the connection binding information is a hard state that should be replicated in the backup node. Consequently, the primary dispatcher was programmed to keep a log of latest changes of connection binding information and the log information concerning the state changes was periodically replicated to its backup node so as to refresh the replicated table. If the primary should fail, the backup can take over the primary's job with the replicated state. However, in case of takeover, some state information for newly setup connections may be unavailable because the replicated state table has not yet been refreshed, or because the periodic refresh messages were lost. The kernel module in the back-end server can cover this situation, since these modules also hold the connection binding information. If one server node does not receive packets from the dispatcher for a long time, it will broadcast a message to query the existence of the backup dispatcher, and then register its binding information to it.

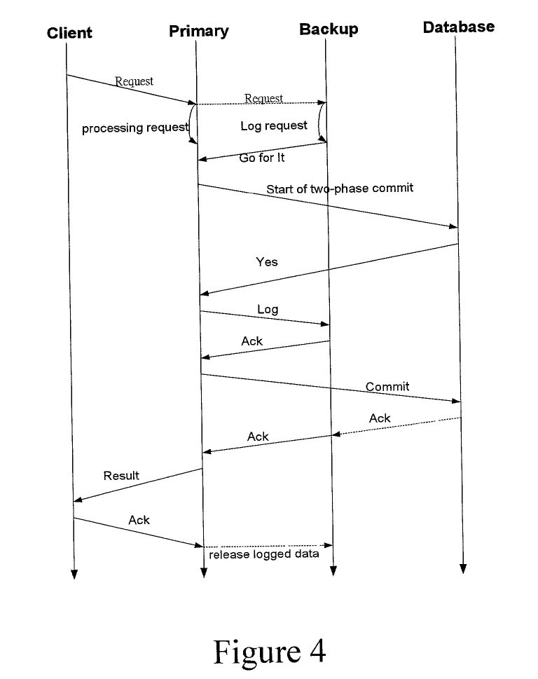

The flowchart of FIG. 4 illustrates the method of request processing in the event of server failure in accordance with a preferred embodiment of the invention. In general, the method of the invention detects at step 410 if a server failure or overload has occurred after request process start at step 400. If there is no failure or overload, the entire system proceeds to request process stop step 450 for normal request processing. If failure or overload during the processing of any request does occur, the method of the invention can be engaged to ensure zero-loss web service. As is illustrated in the flowchart, also as is described in detail in the previous paragraphs, the request migration and recovery processing can be effected in accordance with the type of request that is involved. Migration and recovery processing for the three types of requests, static, dynamic, or session, can be determined in steps 420, 430 and 440 respectively, and the corresponding remedy in the form of static request migration 422, dynamic request migration 432, and session request migration 442 respectively. After the request recovery, the processing can continue normally at step 450 again.

Thus, the above descriptive paragraphs have concentrated on the design and implementation of the request migration mechanism that is essential to implement fault-tolerant web services. Various simulations and tests have led to results that demonstrated and confirmed the fact that the mechanism of the zero-loss web service system and method of the invention offers a powerful solution to support fault-resilience for Web services.

For example, in one long-running test, a most noteworthy result showed that the total error rate of the experiment was zero. In other words, no request failed despite the fact that some nodes of the servers system were intentionally disabled to simulate server failure. In that particular simulation, when one server node failed, the outstanding requests on the failed node were smoothly migrated to another available node in the system. When three nodes failed, the dispatcher discovered that the system suffered overload and successfully recruited two spare nodes to share the load. Within a short period of time, a matter of a few seconds, the entire system stabilized and returned to normal. Such tests effectively proved that the web service system and method as disclosed by the present invention was able to achieve zero loss fault tolerance as well as relieving service overloads.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A system for providing zero-loss routing to clients communicating via a communications network utilizing client access requests having predetermined address parameters, said system comprising:
a plurality of servers communicable with each other; and
a dispatcher including a routing mechanism, communicable with the communications network and with said plurality of servers, said dispatcher dispatching an access request to one of said plurality of servers responsive to the predetermined address parameters, and said routing mechanism migrating said access request to another one of said plurality of servers responsive to a failure in said one of said plurality of servers.

2. The system of claim 1, wherein said dispatcher further comprises a network switch for network connecting said dispatcher to said plurality of servers.

3. The system of claim 1, wherein said dispatcher is a personal computer-based dedicated dispatching computer.

4. The system of claim 1, wherein said dispatcher is a microcontroller-based dedicated dispatcher.

5. The system of claim 1, wherein said dispatcher further comprises a plurality of discrete dispatchers communicable in a dispatcher network, said plurality of discrete dispatchers dispatching the client access requests in cooperation as an entirety for distribution to said one of said plurality of servers.

6. The system of claim 5, wherein each of said plurality of discrete dispatchers is a personal computer-based dedicated dispatching computer.

7. The system of claim 5, wherein said dispatcher is a microcontroller-based dedicated dispatcher.

8. The system of claim 1, wherein said communications network is the Internet.

9. The system of claim 1, wherein said communications network is a corporate intranet.

10. A system for providing zero-loss routing to clients communicating via a communications network utilizing client access requests having predetermined address parameters, said system comprising:
a server cluster including a plurality of servers communicable with each other, said plurality of servers being teamed up in a plurality of twin servers each including a primary server and a backup server; and
a dispatcher including a routing mechanism, communicable with the communications network and with said server cluster, said dispatcher dispatching said access request requesting for a session-based service to the primary server of one of said twin servers committed to said access request responsive to the predetermined address parameters, and said routing mechanism migrating said access request to the backup server of said committed twin server responsive to a failure in said primary server.

11. The system of claim 10, wherein said dispatcher further appoints a server in said server cluster as a replacement backup server responsive to a failure in said backup server of said committed twin server.

12. The system of claim 10, wherein said backup server of said committed twin server is synchronized with said primary server of said committed twin server for said migration of said access request by logging said access request dispatched to said primary server of said committed twin server.

13. A method for providing zero-loss information access service in a system including a plurality of servers routing information to clients communicating via a communications network utilizing client access requests having predetermined address parameters, said method comprising the steps of:
a) discriminating an access request into a request for either static information, dynamic information or session-based service;
b) dispatching said access request to one of said plurality of servers responsive to the predetermined address parameters; and
c) migrating said access request requesting for a session-based service to another one of said plurality of servers responsive to a failure in said one of said plurality of servers.

14. A method for providing zero-loss information access service in a system including a plurality of servers routing information to clients communicating via a communications network utilizing client access requests having predetermined address parameters, said method comprising the steps of:
a) discriminating an access request into a request for either static information, dynamic information or session-based service;
b) teaming up a committed twin server of a primary server and a backup server selected from said plurality of servers;
c) processing said access request for session-based service in said primary server of said committed twin server responsive to said predetermined address parameters; and
d) migrating said access request for session-based service to said backup server of said committed twin server responsive to a failure in said primary server.

15. The method of claim 14, wherein said step c) of processing said access request for session-based service further comprises the steps of:
c1) said backup server synchronizing said access request for session-based service with said primary server by logging said access request; and
c2) said backup server logging the data produced by a database server of said system as the result to said access request for session-based service.

16. The method of claim 15, wherein said step d) of migrating said access request for session-based service to said backup server further comprises the steps of:
d1) relaying said logged data to said client; and
d2) abandoning said logged data.

17. The method of claim 14, wherein said step c) of processing said access request for session-based service further comprises the steps of:
c1) said backup server synchronizing said access request for session-based service with said primary server by logging said access request
c2) said primary server committing a two-phase committing protocol with a database server of said system;
c3) said database server generating data responsive to said two-phase committing protocol as the result to said access request for session-based service; and
c4) said backup server logging said data produced by said database server as the result to said access request for session-based service.

18. The method of claim 17, wherein said step d) of migrating said access request for session-based service to said backup server further comprises the steps of:
d1) relaying said logged data to said client; and
d2) abandoning said logged data.

19. The method of claim 14, wherein said step c) of processing said access request for session-based service further comprises the steps of:
c1) said backup server synchronizing said access request for session-based service with said primary server by logging said access request
c2) said primary server committing a two-phase committing protocol with a database server of said system;
c3) said database server generating data responsive to said two-phase committing protocol as the result to said access request for session-based service; and
c4) said backup server logging said data produced by said database server as the result to said access request for session-based service; and
said step d) of migrating said access request for session-based service to said backup server further comprises the steps of:
d1) relaying said logged data to said client; and
d2) abandoning said logged data.
